(19) United States
(12) Patent Application Publication
(10) Pub. No.: US 2026/0003364 A1
(43) Pub. Date: Jan. 1, 2026

(54) WATER SURFACE OBSTACLE AVOIDANCE MOVEMENT METHOD OF CLEANING APPARATUS

(71) Applicant: Aiper Global Pte. Ltd., Singapore (SG)

(72) Inventors: Gujie Tang, Suzhou (CN); Qingxiang Song, Suzhou (CN); Kai Zheng, Suzhou (CN); Liang Bao, Suzhou (CN)

(21) Appl. No.: 18/895,387

(22) Filed: Sep. 25, 2024

(30) Foreign Application Priority Data
Jul. 1, 2024 (CN) 202410877871.5

(51) Int. Cl. G05D 1/622; E04H 4/16; G05D 105/10; G05D 107/00

(52) U.S. Cl. CPC G05D 1/622; E04H 4/1654; G05D 2105/10; G05D 2107/29

(57) ABSTRACT

The present application discloses a water surface obstacle avoidance movement method of a cleaning apparatus, which is applied to a cleaning apparatus, the cleaning apparatus including a detection unit for detecting obstacles in a first direction, a second direction and a third direction of the cleaning apparatus, the method including the following steps: detecting obstacles in the three directions in real time; when the detection unit detects the obstacle in at least one direction, generating a steering decision according to detection results of the other two directions and performing the steering decision. Based on the obstacle avoidance strategy, the cleaning apparatus can effectively avoid the obstacle and achieve collision-free driving.

### CROSS-REFERENCE TO RELATED APPLICATIONS

This application claims priority to Chinese Patent Application No. 202410877871.5, filed on July 1, 2024, the content of which is incorporated herein by reference in its entirety.

### TECHNICAL FIELD

The present application relates to the technical field of machine automated cleaning, and in particular to a water surface obstacle avoidance movement method of a cleaning apparatus.

### BACKGROUND

At present, the cleaning of water-using areas such as swimming pools is achieved on the basis of cleaning robots. The cleaning robots generally include an over-water robot, an under-water robot, or a robot provided with a water surface mode and an under-water mode. However, the cleaning robot in the prior art does not have a control algorithm for obstacle avoidance during the movement on the water surface, resulting in the robot easily touching the wall during the movement.

### SUMMARY

The technical problem to be solved by the present application is: to provide a water surface obstacle avoidance movement method of a cleaning apparatus, so that the cleaning apparatus can effectively avoid obstacles.

In order to solve the above technical problem, the technical solution adopted by the present application is: a water surface obstacle avoidance movement method of a cleaning apparatus, wherein the cleaning apparatus includes a detection unit for detecting obstacles in a first direction, a second direction and a third direction of the cleaning apparatus, and the method includes the following steps:

detecting obstacles in the three directions in real time; and

when the detection unit detects the obstacle in at least one direction, generating a steering decision according to detection results of the other two directions and performing the steering decision.

The advantageous effects of the present application are as follows: target signals of obstacles in three directions are detected by a distance measurement unit, and a steering judgment is made based on detection results at the same time, and obstacles in the three directions are detected in real time; and when the detection unit detects the obstacle in at least one direction, a steering decision is generated according to the detection results of the other two directions and the steering decision is performed, so that the cleaning apparatus can effectively avoid the obstacle and achieve collision-free driving.

Secondly, the present application also provides an escape strategy, when the water surface obstacle avoidance is trapped, the cleaning apparatus can escape according to the corresponding escape strategy, so that the cleaning equipment is more intelligent.

### BRIEF DESCRIPTION OF THE DRAWINGS

FIG. 1 is a flow chart showing steps of a water surface obstacle avoidance movement method of a cleaning apparatus according to an example of the present application;

FIG. 2 is a schematic view in three directions of a detection unit of a cleaning apparatus according to an example of the present application; and

FIG. 3 is a signal schematic view showing a water surface obstacle avoidance movement method of a cleaning apparatus according to an example of the present application.

### DETAILED DESCRIPTION OF THE EMBODIMENTS

In order to explain the technical contents, the objects, and the effects of the present application in detail, the embodiments will be described below with reference to the accompanying drawings.

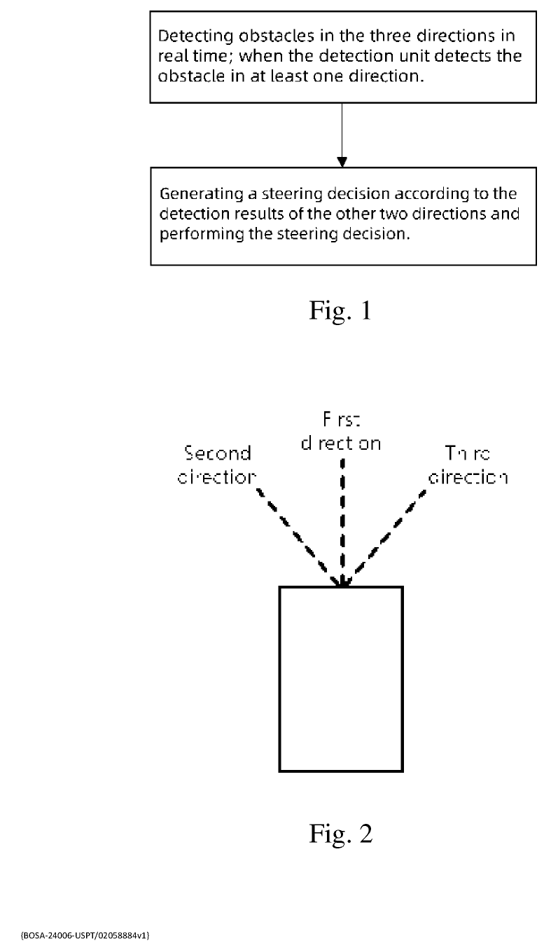

With reference to FIG. 1, a water surface obstacle avoidance movement method of a cleaning apparatus is applied to a cleaning apparatus, the cleaning apparatus including a detection unit for detecting obstacles in a first direction, a second direction and a third direction of the cleaning apparatus, the method including the following steps:

detecting obstacles in the three directions in real time;

when the detection unit detects the obstacle in at least one direction, generating a steering decision according to detection results of the other two directions and performing the steering decision.

As apparent from the above description, the advantageous effects of the present application are as follows: target signals of obstacles in three directions are detected by a distance measurement unit, and a steering judgment is made based on detection results at the same time, and obstacles in the three directions are detected in real time; and when the detection unit detects the obstacle in at least one direction, a steering decision is generated according to the detection results of the other two directions and the steering decision is performed, so that the cleaning apparatus can effectively avoid the obstacle and achieve collision-free driving.

Further, the three directions include a first direction, a second direction, and a third direction; and the first direction is an advancing direction of the cleaning apparatus, the second direction is located on the left side of the first direction, and the third direction is located on the right side of the first direction in the same plane when the water surface of the cleaning apparatus is operated.

Further, the second direction and the third direction form the same preset angle with the first direction; preferably, the preset angle is between 30° and 60°.

It can be seen from the above description that after the first direction is set as the advancing direction, the second direction and the third direction are respectively set on two sides of the first direction and form the same preset angle with the first direction, so that the cleaning apparatus can judge the position relationship with the obstacle based on the signal directly in front and the signals on the two sides thereof, thereby making an effective steering decision.

Further, when the detection unit detects the obstacle, one of the following two cases is included:

when the detection unit detects that there is no obstacle in front to the obstacle existing;

or when the detection unit detects that the distance to the obstacle reaches a preset distance threshold.

It can be seen from the above description that when the detection unit detects that there is no obstacle in front to the obstacle existing, it can be understood that the detection unit is only used for detecting whether there is an obstacle in front, and the return value is 0 or 1, and when there is no obstacle in front, the return value is 0; when there is an obstacle in front, the return value is 1; whether there is an obstacle in front is detected by this detection method, and a steering strategy is performed according to whether there is an obstacle.

In addition, when the detection unit detects that the distance to the obstacle reaches a preset distance threshold value, it can be understood that the detection unit can be used for detecting whether there is an obstacle in front, and a distance value to the obstacle, and when the distance to the obstacle reaches the preset distance threshold value, it can be considered that there is an obstacle in front, so as to perform a steering strategy.

Further, generating a steering decision according to the detection results of the other two directions and performing the steering decision includes:

when an obstacle is detected only in a first direction, performing left or right rotation by a first random angle; preferably, the first random angle is between 120° and 140°.

when an obstacle is detected only in a second direction, performing right rotation by a second random angle; preferably, the second random angle is between 60° and 80°.

when an obstacle is detected only in a third direction, performing left rotation by a third random angle; preferably, the third random angle is between 60° and 80°.

It can be seen from the above description that when an obstacle is detected only in the first direction, it is indicated that the cleaning apparatus basically faces the obstacle, and the obstacle can be effectively avoided by rotating 120°-140°; when an obstacle is detected only in the second direction or the third direction, it is indicated that there is a left or right inclination angle of the cleaning apparatus, the cleaning apparatus is controlled to rotate by a corresponding angle based on the left inclination angle or the right inclination angle, so that the obstacle can be effectively avoided.

### Further, generating a steering decision according to the detection results of the other two directions and performing the steering decision includes:

when an obstacle is detected only in a first direction and a second direction, performing a right rotation by a fourth random angle; preferably, the fourth random angle is between 100° and 120°.

It can be seen from the above description that when an obstacle is detected only in the first direction and the second direction, it is indicated that the cleaning apparatus has a small inclination angle and requires a large angular rotation.

Further, generating a steering decision according to the detection results of the other two directions and performing the steering decision includes:

when an obstacle is detected only in a first direction and a third direction, performing a left rotation by a fifth random angle; preferably, the fifth random angle is between 100° and 120°.

It can be seen from the above description that the steering decision can be adjusted according to the original inclination angle, thereby improving the accuracy of the steering decision.

Further, the generating a steering decision from all the distance values and performing the steering decision further includes:

judging whether the cleaning apparatus is in a trapped state by counting the number of turns of the cleaning apparatus over a period of time, and if it is in the trapped state, performing an escape strategy.

Specifically, judging whether the cleaning apparatus is in a trapped state by counting the number of turns of the cleaning apparatus over a period of time, including the following steps:

acquiring a steering count value and adding one to the steering count value; and when the steering count value reaches a count threshold value, reporting a pre-warning state and resetting the steering count value.

It can be seen from the above description that by counting the number of times the cleaning apparatus performs a steering operation, when the cleaning apparatus performs multiple times, it is indicated that the cleaning apparatus may be at risk of being in distress, and by reporting a pre-warning state, the current state is monitored to further judge whether it is in distress.

Further, after reporting the pre-warning state, it further includes:

starting a timer and generating a pre-warning count value, and adding the pre-warning count value by one every time the pre-warning state is reported; and when the timer reaches a time threshold and the pre-warning count value reaches a pre-warning threshold, an escape strategy is performed.

It can be seen from the above description that it can be accurately judged whether the cleaning apparatus is in a distress state based on the number of times the cleaning apparatus performs a steering operation within a preset time, so as to reduce the situation of misjudgment.

Further, the escape strategy includes:

controlling the cleaning apparatus to sequentially perform the operations of submerging, advancing for a preset distance, and floating to the water surface.

It can be seen from the above description that when the cleaning apparatus is in a distress state, by controlling the cleaning apparatus to successively perform the operations of submerging, advancing for a preset distance, and floating to the water surface, the cleaning apparatus can be separated from the original position, thereby achieving the escape.

Further, after performing the submerging, it further includes: acquiring a pitch value, a yaw value and a roll value of the cleaning apparatus; when the pitch value and the roll value are 0, and the yaw value does not change within a preset time, performing the operation of advancing for a preset distance and floating to the water surface.

It can be seen from the above description that the state of the cleaning apparatus is judged on the basis of a pitch value, a yaw value and a roll value, and when the pitch value and the roll value are 0 and the yaw value does not change within a preset time, it is indicated that the cleaning apparatus has been sunk into the water, and then the cleaning apparatus is controlled to move so as to effectively avoid an obstacle on the water surface.

Further, after starting a timer and generating a pre-warning count value, it further includes: recording each of the steering decisions and an execution sequence of the steering decisions.

After performing floating to the water surface, it further includes:

performing each of the steering decisions generated within the time threshold in turn according to the execution sequence.

It can be seen from the above description that it is ensured that the cleaning robot has escaped by repeatedly performing the previous path planning action.

The water surface obstacle avoidance movement method of a cleaning apparatus provided by the present application can be applied to path planning of a cleaning machine, and is described below by way of specific examples.

### Example 1

A water surface obstacle avoidance movement method of a cleaning apparatus is applied to a cleaning apparatus, wherein the cleaning apparatus includes a detection unit, and a distance measurement unit for detecting target signals of obstacles in at least three directions. For example, a swimming pool cleaning machine is illustrated in the example. Wherein the robot is provided with a crawler belt, and air bags are mounted on two sides of the crawler belt for the robot to float up and submerge down; if the air bag is inflated when the robot floats up, the air bag is deflated when the robot is submerged down. Vector jets are installed on both sides of the robot profile to control the advancing and rotation of the robot in a water surface mode. For example, when the robot moves linearly, the vector jets on both sides will face backward, providing forward thrust; when steering to the left, the left jet will face forward, and the right jet will face backward, so that the thrust directions of the two sides are different to achieve the ability to rotate; similarly, a right turn operation is performed. The distance measurement unit is arranged on the front side of the robot and can be a three-in-one ultrasonic wave; meanwhile, an IMU (Inertial Measurement Unit) is installed inside the robot to provide support for the rotation angle of the robot.

Wherein, when the robot is in a water surface mode, the robot will lose the positioning capability due to the inertia of water surface. To ensure cleaning coverage, a rotational random planning scheme is used. The robot moves linearly at first, and rotates randomly based on the steering decision when the obstacle is detected by the front ultrasonic wave. The steering decision method specifically includes the following contents:

S1, according to the received target signal of at least one direction, acquiring a detection result corresponding to the target signal; wherein as shown in FIG. 2, the present embodiment includes a first direction, a second direction, and a third direction. In the same plane when the water surface of the cleaning apparatus is operated, the first direction is the advancing direction of the cleaning apparatus, the second direction and the third direction are respectively set on the left side and the right side of the first direction, and form the same preset angle with the first direction; preferably, the preset angle is between 30° and 60°; the preset angle can be selected according to actual design requirements, for example, 30°, 40°, 50° or 60° can be selected.

S2, when the detection unit detects the obstacle in at least one direction, generating a steering decision according to the detection results of the other two directions and performing the steering decision, namely, avoiding the forward obstacle by means of the steering decision;

wherein, when the detection unit detects the obstacle, one of the following two cases is included:

1) when the detection unit detects that there is no obstacle in front to the obstacle existing; and

2) when the detection unit detects that the distance to the obstacle reaches a preset distance threshold.

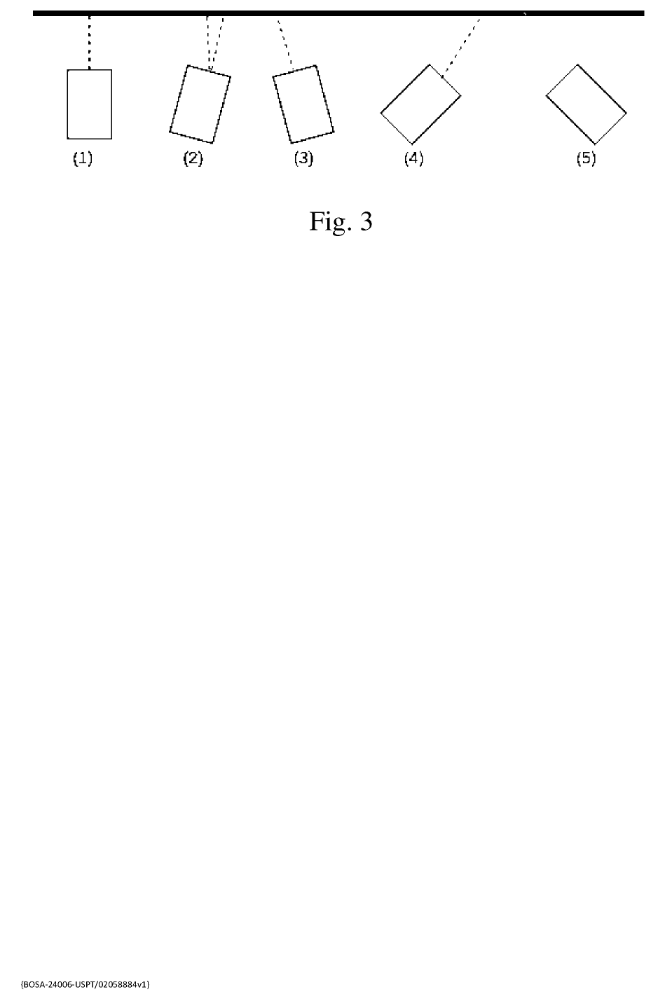

For the second case, as detailed in the present example, for example, the preset distance threshold is set to 45 cm, i.e. when the distance value reaches 45 cm, steering to obstacle avoidance can be started. Wherein the preset distance threshold value can be determined according to the size and movement capability of the robot; for example, by inputting the corresponding model of the robot, the system can calculate the preset distance threshold according to the corresponding size. At the same time, it is also possible to perform steering control on the basis of the posture information about the current robot so as to make the rotation more reliable, specifically: referring to FIG. 3, generating a steering decision according to the detection results of the other two directions and performing the steering decision include:

1) when an obstacle is detected only in a first direction, performing a rotation by a first random angle; preferably, the first random angle is between 120° and 140°. As shown in (1) of FIG. 3, when it is considered that the robot basically faces the wall, and it is judged that a random rotation of 120°-140° to the right or to the left is required.

2) When an obstacle is detected only in a first direction and a second direction, performing a right rotation by a fourth random angle; preferably, the fourth random angle is between 100° and 120°. As shown in (2) of FIG. 3, when it is considered that the robot inclines to the wall to the right and has a small inclination angle, and it is judged that a random rotation of 100°-120° to the right is required.

3) When an obstacle is detected only in a second direction, performing right rotation by a second random angle; preferably, the second random angle is between 60° and 80°. As shown in (4) of FIG. 3, when it is considered that the robot inclines to the wall to the right and has a large inclination angle, and it is judged that a random rotation of 60°-80° to the right is required.

4) When an obstacle is detected only in a first direction and a third direction, performing a left rotation by a fifth random angle; preferably, the fifth random angle is between 100° and 120°. As shown in (3) of FIG. 3: when it is considered that the robot inclines to the wall to the left and has a small inclination angle, and it is judged that a random rotation of 100°-120° to the left is required.

5) When an obstacle is detected only in a third direction, performing left rotation by a third random angle; preferably, the third random angle is between 60° and 80°. As shown in (5) of FIG. 3, when it is considered that the robot inclines to the wall to the left and has a large inclination angle, and it is judged that a random rotation of 60°-80° to the left is required.

In another alternative embodiment, for example, a first direction, a second direction, a third direction, a fourth direction, and a fifth direction are included; wherein the second direction and the third direction are provided on the left side of the first direction, and the fourth direction and the fifth direction are set on the right side of the first direction; then in a second decision and a third decision in the steering decision, for example in the second decision, different rotation angles may be set according to the situation including the first direction, the second direction and the third direction to control the rotation angle of the robot according to the inclination angle between the robot and the wall. Similarly, when multiple directions are included, the angular rotation is performed according to the case where multiple directions are included.

### Example 2

The example is different from Example 1 in that it specifically describes the escape logic of the robot. Describing according to the swimming pool cleaning machine in the example, for example, when the swimming pool cleaning machine performs a steering decision based on the method in Example 1, the following steps are performed:

judging whether the cleaning apparatus is in a trapped state by counting the number of turns of the cleaning apparatus over a period of time, and if it is in the trapped state, performing an escape strategy.

The detailed steps are as follows:

S3, acquiring a steering count value, and adding one to the steering count value; for example, the steering count value is set to a, and once the robot performs the steering decision, the steering count value a is counted, and the steering count value a + 1 is set.

S4, when the steering count value reaches the count threshold value, the pre-warning state is reported and the steering count value is reset. For example, if the counting threshold value is five times, when the steering count value a counts to five, the re-warning state is reported; and the count of the steering count value a is cleared.

Monitoring the current state of the robot after reporting the pre-warning state, specifically:

S5, starting a timer and generating a pre-warning count value, and adding the pre-warning count value by one every time the pre-warning state is reported. For example, if the generated pre-warning count value is set to b, when the steering count value a counts to 5, the pre-warning count value b + 1 is set. Meanwhile, each steering decision and the execution sequence of the steering decisions are recorded during the period.

S6, when the timer reaches a time threshold and the pre-warning count value reaches a pre-warning threshold, an escape strategy is performed. For example, the time threshold is 5 minutes, and the pre-warning threshold is 3; then, when the robot reports two pre-warning states within 5 minutes (when the timer is started for the first time, the pre-warning count value b is 1), it is considered that the robot is trapped in a local area, and then the escape logic is triggered. Wherein, the time threshold value and the pre-warning threshold value can be set according to actual situations.

Specific escape logics include: controlling the cleaning apparatus to successively perform the operations of submerging, advancing for a preset distance, and floating to a water surface, specifically: controlling the air bag to deflate so that the robot enters the pool bottom; at the same time, the rotation state of the robot is monitored in real time through IMU data, wherein the IMU data includes a pitch value, a yaw value and a roll value; when the pitch value and the roll value are basically 0, for example, the values of the pitch value and the roll value are in the range of 0-2, the values thereof are considered to be about 0; and when the yaw value does not change within a preset time, controlling the robot to move forward for a distance. The air bag inflation is then controlled to float the robot up and each steering decision generated within the time threshold is performed in turn according to the execution sequence, i.e. the previous path planning action is repeated.

In summary, the present application provides a water surface obstacle avoidance movement method of a cleaning apparatus, wherein target signals of obstacles in at least three directions are detected by a distance measurement unit, and a distance value corresponding to the received target signals is acquired, and a steering judgment is made based on the distance value at the same time, and a steering decision is generated and performed through all the distance values only when the distance value reaches a preset distance threshold value, so that the cleaning apparatus can effectively avoid the obstacle and achieve collision-free driving. At the same time, after the cleaning apparatus reports the pre-warning state, it is judged whether the cleaning apparatus is in a distress state by monitoring the number of times the cleaning apparatus performs a steering operation within a preset time, and when it is judged that the cleaning apparatus is in a distress state, an escape strategy is performed, so as to reduce the jamming in a narrow area as much as possible.

The above description is only an example of the present application, and is not intended to limit the patent scope of the present application, and all equivalent transformations performed by using the contents of the specification and the drawings of the present application or directly or indirectly applied to the related technical fields are included in the patent protection scope of the present application.

1. A water surface obstacle avoidance movement method of a cleaning apparatus, wherein the cleaning apparatus comprises a detection unit for detecting obstacles in a first direction, a second direction and a third direction of the cleaning apparatus, and the method comprises:
detecting obstacles in the three directions in real time;
generating a steering decision according to detection results of the other two directions and performing the steering decision, when the detection unit detects the obstacle in at least one direction.

2. The water surface obstacle avoidance movement method of a cleaning apparatus according to claim 1, wherein the first direction is an advancing direction of the cleaning apparatus, the second direction is on a left side of the first direction, and the third direction is on a right side of the first direction.

3. The water surface obstacle avoidance movement method of a cleaning apparatus according to claim 2, wherein when the detection unit detects the obstacle, one of the following two cases is comprised:
when the detection unit detects that there is no obstacle in front to the obstacle existing;
or when the detection unit detects that a distance to the obstacle reaches a preset distance threshold.

4. The water surface obstacle avoidance movement method of a cleaning apparatus according to claim 1, wherein generating a steering decision according to detection results of the other two directions and performing the steering decision comprises:
when an obstacle is detected only in a first direction, performing left or right rotation by a first random angle; the first random angle is between 120° and 140°.

5. The water surface obstacle avoidance movement method of a cleaning apparatus according to claim 2, wherein generating a steering decision according to detection results of the other two directions and performing the steering decision comprises:
when an obstacle is detected only in a first direction, performing left or right rotation by a first random angle; the first random angle is between 120° and 140°.

6. The water surface obstacle avoidance movement method of a cleaning apparatus according to claim 3, wherein generating a steering decision according to detection results of the other two directions and performing the steering decision comprises:
when an obstacle is detected only in a first direction, performing left or right rotation by a first random angle; the first random angle is between 120° and 140°.

7. The water surface obstacle avoidance movement method of a cleaning apparatus according to claim 1, wherein generating a steering decision according to detection results of the other two directions and performing the steering decision comprises:
when an obstacle is detected only in a second direction, performing right rotation by a second random angle; the second random angle is between 60° and 80°.

8. The water surface obstacle avoidance movement method of a cleaning apparatus according to claim 2, wherein generating a steering decision according to detection results of the other two directions and performing the steering decision comprises:
when an obstacle is detected only in a second direction, performing right rotation by a second random angle; the second random angle is between 60° and 80°.

9. The water surface obstacle avoidance movement method of a cleaning apparatus according to claim 3, wherein generating a steering decision according to detection results of the other two directions and performing the steering decision comprises:
when an obstacle is detected only in a second direction, performing right rotation by a second random angle; the second random angle is between 60° and 80°.

10. The water surface obstacle avoidance movement method of a cleaning apparatus according to claim 1, wherein generating a steering decision according to detection results of the other two directions and performing the steering decision comprises:
when an obstacle is detected only in a third direction, performing left rotation by a third random angle; the third random angle is between 60° and 80°.

11. The water surface obstacle avoidance movement method of a cleaning apparatus according to claim 2, wherein generating a steering decision according to detection results of the other two directions and performing the steering decision comprises:
when an obstacle is detected only in a third direction, performing left rotation by a third random angle; the third random angle is between 60° and 80°.

12. The water surface obstacle avoidance movement method of a cleaning apparatus according to claim 3, wherein generating a steering decision according to detection results of the other two directions and performing the steering decision comprises:
when an obstacle is detected only in a third direction, performing left rotation by a third random angle; the third random angle is between 60° and 80°.

13. The water surface obstacle avoidance movement method of a cleaning apparatus according to claim 1, wherein generating a steering decision according to detection results of the other two directions and performing the steering decision comprises:
when an obstacle is detected only in a first direction and a second direction, performing a right rotation by a fourth random angle; the fourth random angle is between 100° and 120°.

14. The water surface obstacle avoidance movement method of a cleaning apparatus according to claim 2, wherein generating a steering decision according to detection results of the other two directions and performing the steering decision comprises:
when an obstacle is detected only in a first direction and a second direction, performing a right rotation by a fourth random angle; the fourth random angle is between 100° and 120°.

15. The water surface obstacle avoidance movement method of a cleaning apparatus according to claim 3, wherein generating a steering decision according to detection results of the other two directions and performing the steering decision comprises:
when an obstacle is detected only in a first direction and a second direction, performing a right rotation by a fourth random angle; the fourth random angle is between 100° and 120°.

16. The water surface obstacle avoidance movement method of a cleaning apparatus according to claim 1, wherein generating a steering decision according to detection results of the other two directions and performing the steering decision comprises:
when an obstacle is detected only in a first direction and a third direction, performing a left rotation by a fifth random angle; the fifth random angle is between 100° and 120°.

17. The water surface obstacle avoidance movement method of a cleaning apparatus according to claim 2, wherein generating a steering decision according to detection results of the other two directions and performing the steering decision comprises:
when an obstacle is detected only in a first direction and a third direction, performing a left rotation by a fifth random angle; the fifth random angle is between 100° and 120°.

18. The water surface obstacle avoidance movement method of a cleaning apparatus according to claim 3, wherein generating a steering decision according to detection results of the other two directions and performing the steering decision comprises:
when an obstacle is detected only in a first direction and a third direction, performing a left rotation by a fifth random angle; the fifth random angle is between 100° and 120°.

19. The water surface obstacle avoidance movement method of a cleaning apparatus according to claim 1, wherein generating a steering decision according to detection results of the other two directions and performing the steering decision further comprises:
judging whether the cleaning apparatus is in a trapped state by counting the number of turns of the cleaning apparatus over a period of time, and if it is in the trapped state, performing an escape strategy.

20. The water surface obstacle avoidance movement method of a cleaning apparatus according to claim 19, wherein the escape strategy comprises:
controlling the cleaning apparatus to sequentially perform the operations of submerging, advancing or retreating for a preset distance and then floating to the water surface.
